(19) United States
(12) Patent Application Publication
(10) Pub. No.: US 2026/0238020 A1
(43) Pub. Date: Aug. 13, 2026

(54) BACKUP POWER SUPPLY SYSTEM AND METHOD FOR CONTROLLING BACKUP POWER SUPPLY SYSTEM

(71) Applicant: Panasonic Intellectual Property Management Co., Ltd., Osaka (JP)

(72) Inventors: TAKESHI UMEDA, Osaka (JP); SHOHEI YAMANAKA, Osaka (JP)

(21) Appl. No.: 19/154,017

(22) PCT Filed: Oct. 31, 2023
(86) PCT No.: PCT/JP2023/039266

§ 371 Date: Aug. 6, 2025

(30) Foreign Application Priority Data
Mar. 30, 2023 (JP) 2023-056708

(51) Int. Cl. H02J 7/34; B60R 16/033; H02J 7/00; H02J 7/90

(52) U.S. Cl. CPC H02J 7/345; B60R 16/033; H02J 7/855; H02J 7/865; H02J 7/971; H02J 2207/50

(57) ABSTRACT

A backup power supply system includes a first port, a second port, a charging circuit, an output circuit, a deterioration detector, and a controller. The charging circuit is configured to charge a power storage unit such that a charging voltage which is a voltage of the power storage unit has a set value with power input from a power supply through the first port. The output circuit is configured to supply power to a load from the power storage unit through the second port during a failure state in which the power supply has failure. The deterioration detector is configured to detect a deterioration state of the power storage unit. The controller is configured to control the set value depending on a detection result of the deterioration detector.

### TECHNICAL FIELD

The present disclosure relates to a backup power supply system and a method for controlling the backup power supply system. More specifically, the present disclosure relates to a backup power supply system configured to supply power to a load from a power storage unit during a failure state in which a power supply has failure, and to a method for controlling the backup power supply system.

### BACKGROUND ART

PTL 1 discloses a power supply device for vehicle. The power supply device includes a power supply backup unit including a capacitor unit including plural capacitors. In this power supply device for vehicle, when a battery of the vehicle is abnormal, power is supplied to an electronic controller of the vehicle from the power supply backup unit.

### CITATION LIST

### Patent Literature

PTL 1: Japanese Patent Laid-Open Publication No. 2004-322987

### SUMMARY OF INVENTION

When the capacitor constituting a capacitor unit (power storage unit) deteriorates, internal resistance of the capacitor increases, and capacity of the capacitor decreases. This reduces a power storage amount that can be stored in the capacitor unit.

The backup power supply system of an aspect of the present disclosure includes a first port, a second port, a charging circuit, an output circuit, a deterioration detector, and a controller. The first port is configured to be connected to a power supply. The second port is configured to be connected to a load. The charging circuit is configured to charge a power storage unit such that a charging voltage which is a voltage of the power storage unit has a set value with power input from the power supply through the first port. The output circuit is configured to supply power to the load from the power storage unit through the second port during a failure state in which the power supply has failure. The deterioration detector is configured to detect a deterioration state of the power storage unit. The controller is configured to control the set value depending on a detection result of the deterioration detector.

A method for controlling the backup power supply system in an aspect of the present disclosure is a method for controlling a backup power supply system including a first port, a second port, a charging circuit, and an output circuit. The method includes deterioration detection processing and control processing. The first port is configured to be connected to a power supply. The second port is configured to be connected to a load. The charging circuit is configured to charge a power storage unit such that a charging voltage which is a voltage of the power storage unit has a set value with power input from the power supply through the first port. The output circuit is configured to supply power to the load from the power storage unit through the second port during a failure state in which the power supply has a failure. In the deterioration detection processing, a deterioration state of a power storage unit is detected. In the control processing, the set value is controlled according to a detection result of the deterioration state of the power storage unit.

The present disclosure provides a backup power supply system extending a life of the power storage unit, and a method for controlling the backup power supply system.

### BRIEF DESCRIPTION OF DRAWINGS

FIG. 1 is a schematic block circuit diagram of a backup power supply system in accordance with an exemplary embodiment of the present disclosure.

FIG. 2 shows a relationship between cumulative use time and capacity of a power storage unit in the backup power supply system.

FIG. 3 shows a relationship between cumulative use time and internal resistance of the power storage unit in the backup power supply system.

FIG. 4 shows a relationship between cumulative use time of the power storage unit and a set value of a charging voltage of the backup power supply system.

FIG. 5 shows a relationship between cumulative use time and capacity of the power storage unit of the backup power supply system.

FIG. 6 is a flowchart describing an operation of the backup power supply system.

FIG. 7 is a flowchart describing an operation of the backup power supply system.

FIG. 8 shows changes with respect to time of power supply to a load and a terminal voltage of the power storage unit when power is supplied to the load from the power storage unit in an initial use stage of the power storage unit.

FIG. 9 shows changes with respect to time of the terminal voltage of the power storage unit when power is supplied to the load from the power storage unit in an end-of-life state in which cumulative use time of the power storage unit exceeds the lifetime.

FIG. 10 shows a relationship between cumulative use time of the power storage unit and the set value of the charging voltage in a first modification of the backup power supply system.

### DESCRIPTION OF EMBODIMENT

A backup power supply system in accordance with an exemplary embodiment and a method for controlling the backup power supply system will be detailed below with reference to the drawings. Note that, the compositions described in the following exemplary embodiments are mere examples of the present disclosure. The present disclosure is not limited to the following exemplary embodiments, and various modifications can be performed according to the design or the like if effects of the present disclosure are achievable.

### Exemplary Embodiment

### (1) Summary

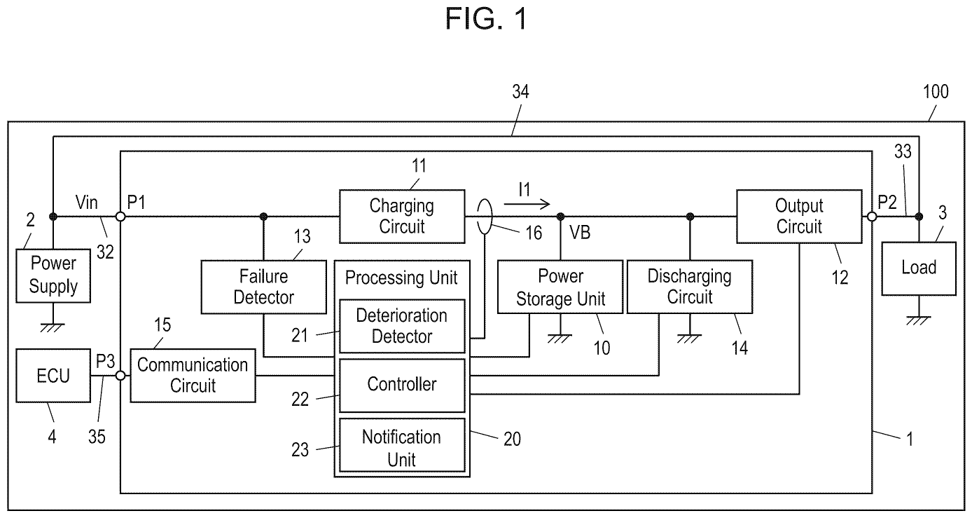

FIG. 1 is a schematic block circuit diagram of backup power supply system 1 in accordance with the exemplary embodiment.

Backup power supply system 1 includes first port P1, second port P2, charging circuit 11, output circuit 12, deterioration detector 21, and controller 22.

First port P1 is configured to be connected to power supply 2.

Second port P2 is configured to be connected to load 3.

Charging circuit 11 is configured to charge power storage unit 10 such that a charging voltage which is a voltage of power storage unit 10 has a set value with power input from power supply 2 through first port P1.

Output circuit 12 is configured to supply power to load 3 from power storage unit 10 through second port P2 during a failure state in which power supply 2 has failure.

Deterioration detector 21 is configured to detect a deterioration state of power storage unit 10.

Controller 22 is configured to control, according to a detection result of deterioration detector 21, the set value of the charging voltage when charging circuit 11 charges power storage unit 10.

Power supply 2 is connected to first port P1 through electric wire 32, and load 3 is connected to second port P2 through electric wire 33. First port P1 and second port P2 may be components (terminals) to be connected to electric wires 32 and 33, but may be, e.g., leads of electronic components or parts of conductors formed on a circuit board as wiring. Further, the expression of “two elements are connected to each other” means that the two elements are electrically connected to each other, and another element may be interposed between the two elements.

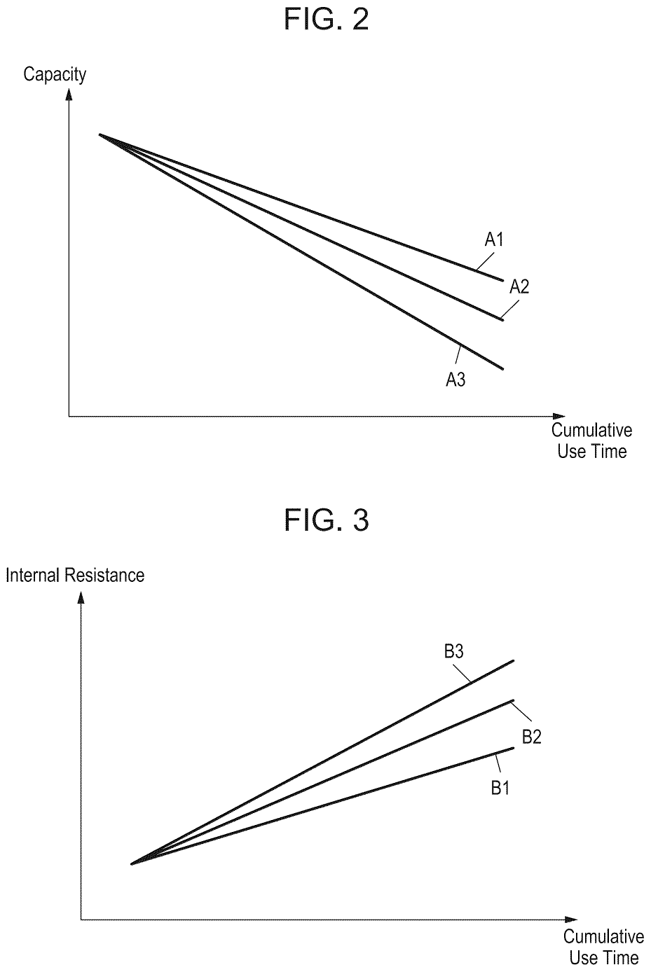

FIG. 2 shows a relationship between cumulative use time and capacity of power storage unit 10. Profiles A1, A2, and A3 in the figure represent changes with respect to time of the capacity when the charging voltage is set to set values V1, V2, and V3 (V1<V2<V3), respectively. Assumed that an initial use stage is defined as a state where cumulative use time of power storage unit 10 is zero, the cumulative use time is time elapsing from the initial use stage of power storage unit 10. The cumulative use time may include time at which no electric charge is stored in power storage unit 10. FIG. 3 shows a relationship between cumulative use time and internal resistance (e.g., series resistance) of power storage unit 10. Profiles B1, B2, and B3 in the figure represent changes with respect to time of the internal resistance when the charging voltage is set to set values V1, V2, and V3 (V1<V2<V3), respectively. As shown in FIGS. 2 and 3, deterioration of power storage unit 10 is advanced as cumulative use time of power storage unit 10 increases. Thus, the capacity of power storage unit 10 decreases and the internal resistance thereof increases. A decreasing rate of the capacity with respect to the cumulative use time increases as the set value of the charging voltage increases, and an increase rate of the internal resistance with respect to the cumulative use time increases. In other words, deterioration of power storage unit 10 is more advanced as the set value of the charging voltage increases.

In the backup power supply system of a comparative example, the set value (target value) of the charging voltage when charging circuit 11 charges power storage unit 10 is set constantly to a fixed value regardless of the deterioration state of power storage unit 10. In this case, in order to supply required power (power required for load 3 to perform a predetermined operation) to load 3 from power storage unit 10 even in an end-of-life stage in which the cumulative use time reaches a predetermined lifetime, the set value of the charging voltage is necessarily set according to a capacity of power storage unit 10 in the end-of-life stage. On the other hand, the capacity of power storage unit 10 is larger and the internal resistance thereof in an initial use stage of power storage unit 10 is lower than with in the end-of-life stage. Therefore, in power storage unit 10, the set value of the charging voltage required for supplying the required power to load 3 at the capacity in the initial use stage is lower than the set value of the charging voltage that has been set according to the capacity in the end-of-life stage. Accordingly, as in the backup power supply system of the comparative example, if the set value of the charging voltage is set according to the capacity in the end-of-life stage, power storage unit 10 is charged at an unnecessarily high voltage value in the initial use stage. This accelerates deterioration of power storage unit 10. Note that, the lifetime, described herein, means a period from the start of use of power storage unit 10 to the time when the power required for load 3 to perform a predetermined operation is hardly supplied.

In backup power supply system 1 according to the present exemplary embodiment, however, controller 22 is configured to control the set value of the charging voltage when charging circuit 11 charges power storage unit 10, according to a detection result of deterioration detector 21. For instance, in the initial use stage in which capacity of power storage unit 10 is larger and internal resistance thereof is smaller than in the end-of-life stage of power storage unit 10, controller 22 controls the set value of the charging voltage to cause the set value of the charging voltage to be lower than a voltage value in the end-of-life stage. Deterioration of power storage unit 10 is advanced more as the set value of the charging voltage of power storage unit 10 increases. Therefore, controller 22 controls the set value of the charging voltage in the initial use stage to be lower than the set vale in, e.g., the end-of-life stage, thereby suppressing deterioration of power storage unit 10. Thus, progress of deterioration of power storage unit 10 can be prevented, thereby making it possible to extend a life of power storage unit 10.

### (2) Details

Backup power supply system 1 in accordance with the present exemplary embodiment will be detailed below with reference to FIGS. 1 through 9.

### (2.1) Configuration

Backup power supply system 1 of the present exemplary embodiment is configured to be mounted to vehicle 100 (see FIG. 1), such as a car. Vehicle 100 has power supply 2 and load 3 mounted thereto. Backup power supply system 1 mounted in vehicle 100 is configured to supply power to load 3 mounted to vehicle 100.

Power supply 2 which is configured to be connected to first port P1 through electric wire 32 may be a battery of vehicle 100.

Load 3 configured to be connected to second port P2 through electric wire 33 may be an electrical device mounted to vehicle 100. Load 3 may be, e.g., an electro-mechanical brake system or a shift-by-wire system. Alternatively, load 3 may be a control system configured to control the electro-mechanical brake system or the shift-by-wire system, or may be advanced driver-assistance systems (ADAS). Load 3 is not limited to one electrical device, but may include plural electrical devices.

Backup power supply system 1 is configured to supply power to load 3 from power storage unit 10 during a failure state in which power supply 2 (e.g., a battery of a car) of vehicle 100 has failure. Thus, even in the failure state of power supply 2, load 3 operates with the power supplied from power storage unit 10. During a non-failure state in which power supply 2 does not have failure, power is supplied to load 3 from power supply 2 through, e.g., power supply line 34 provided in the outside of backup power supply system 1.

The failure state of power supply 2 means a state where voltage Vin decreases to less than a predetermined reference voltage due to a failure of power supply 2 or a ground fault in power supply 2 or electric wire 32 that connects first port P1 to power supply 2. Voltage Vin is input to first port P1 from power supply 2. The non-failure state of power supply 2 means a state where voltage Vin input to first port P1 from power supply 2 is higher than or equal to the reference voltage. This reference voltage may be lower than a rated voltage of power supply 2. The reference voltage is preferably higher than the minimum operating voltage (also referred to as minimum guaranteed voltage) required for load 3 to operate normally. Note that, the minimum operating voltage of load 3 is a lower limit of operating voltage required for load 3 to operate, or a voltage obtained by adding a predetermined margin voltage to the lower limit of operating voltage.

As mentioned above, backup power supply system 1 includes first port P1, second port P2, charging circuit 11, and output circuit 12. Backup power supply system 1 further includes processing unit 20 having above functions of deterioration detector 21 and controller 22. Backup power supply system 1 further includes third port P3, failure detector 13, discharging circuit 14, and communication circuit 15.

Power storage unit 10 includes a cell assembly including plural storage cells connected in series or in parallel to one another. Each storage cell may be an electrical double layer capacitor (EDLC) chargeable and dischargeable rapidly. In other words, power storage unit 10 includes the electrical double layer capacitors.

Charging circuit 11 may include a semiconductor switch such as a metal-oxide-semiconductor field-effect transistor (MOSFET) connected between first port P1 and power storage unit 10. The semiconductor switch is controlled in response to a driving signal input from controller 22 in an ON/OFF state or on-resistance thereof. Charging circuit 11 may further include a drive circuit configured to turn on and off the semiconductor switch in response to the driving signal input from controller 22. The semiconductor switch is turned on and off or has the on-resistance changed in response to the driving signal input from controller 22 so as to allow charging circuit 11 to control a current value of current flowing into power storage unit 10 through the semiconductor switch. Charging circuit 11 thus charge power storage unit 10 with the power input from power supply 2 through first port P1, thereby controlling a charge amount and terminal voltage VB of power storage unit 10. Terminal voltage VB of power storage unit 10 is a voltage at an output terminal of power storage unit 10, and the voltage value of terminal voltage VB is changed depending on charging and discharging of power storage unit 10. The set value of the charging voltage is a set value (target value) when charging circuit 11 charges power storage unit 10. The set value of the charging voltage is also a voltage value of terminal voltage VB when the charging of power storage unit 10 is completed. Charging circuit 11 is configured to charge power storage unit 10 such that the charging voltage which is a voltage of power storage unit 10, has the set value.

Failure detector 13 is configured to detect a voltage value of voltage Vin input to first port P1 from power supply 2, and compare the voltage value of voltage Vin with the reference voltage in magnitude. If the voltage value of voltage Vin is higher than or equal to the reference voltage, failure detector 13 outputs a detection signal to processing unit 20. The detection signal indicates that power supply 2 is in a non-failure state in which power supply 2 does not have failure. If the voltage value of voltage Vin is lower than the reference voltage, failure detector 13 outputs a detection signal to processing unit 20. The detection signal indicates that power supply 2 is in a failure state in which power supply 2 has failure.

Output circuit 12 includes a semiconductor switch, such as a MOSFET, connected between power storage unit 10 and second port P2. The semiconductor switch is controlled to be turned on or off in response to a driving signal input from controller 22. Output circuit 12 may further include a drive circuit configured to control turning on and off of the semiconductor switch in response to a driving signal input from controller 22. Output circuit 12 turns on the semiconductor switch element in response to the driving signal input from controller 22, thereby supplying power to load 3 from power storage unit 10 through output circuit 12 and second port P2.

When a discharge instruction is input from controller 22, discharging circuit 14 causes power storage unit 10 to discharge electric charges stored in power storage unit 10. For instance, discharging circuit 14 includes a series circuit of a switch and a discharge resistor, and the series circuit is connected in parallel with the power storage unit 10. For instance, when a discharge instruction is input from processing unit 20, discharging circuit 14 turns on the switch and discharges the electric charges stored in power storage unit 10 through the discharge resistance.

Third port P3 is configured to be connected to, e.g., communication wire 35 connecting Electronic Control Unit (ECU) 4 of vehicle 100 to communication circuit 15.

Communication circuit 15 includes a communication module in conformity with telecommunications standards used in an in-vehicle network, such as a CAN standard or a LIN standard, and communicates with ECU 4 of vehicle 100, for example.

Processing unit 20 may be implemented by a microcomputer including a processor and a memory. In other words, processing unit 20 is implemented by a computer system including a processor and a memory. When the processor executes an optional program, the computer system functions as processing unit 20. The program may be previously stored in the memory. Alternatively, the program may be provided through an electric telecommunication line, such as the Internet, or may be stored in non-transitory recording media, such as a memory card, and provided. Processing unit 20 is not necessarily implemented by a computer system, but by an analog circuit or a gate drive circuit.

Processing unit 20 has functions of controller 22 and deterioration detector 21 mentioned above. Processing unit 20 further has a function of notification unit 23. Deterioration detector 21, controller 22, and notification unit 23 are merely implemented by functions executed by processing unit 20, but not necessarily implemented by tangible components.

Deterioration detector 21 is configured to detect a deterioration state of power storage unit 10. When use of vehicle 100 is finished (when an ignition key is switched from ON to OFF), processing unit 20 outputs a discharge instruction to discharging circuit 14 to discharge the electric charges stored in power storage unit 10. When vehicle 100 is used again, backup power supply system 1 causes charging circuit 11 to charge power storage unit 10. Deterioration detector 21 includes current sensor 16 configured to detect a current value of current I1 flowing from charging circuit 11 to power storage unit 10 when charging circuit 11 charges power storage unit 10, and obtains terminal voltage VB of power storage unit 10 from power storage unit 10. Deterioration detector 21 calculates internal resistance (direct-current (DC) resistance) of power storage unit 10 based on terminal voltage VB of power storage unit 10 and the current value of current I1 which flows from charging circuit 11 to power storage unit 10. Deterioration detector 21 further calculates a cumulative value (i.e., an amount of charge) of current I1 that has flown into power storage unit 10 until terminal voltage VB of power storage unit 10 reaches a predetermined voltage value. Thus, the capacity of power storage unit 10 is calculated. Then, deterioration detector 21 detects a deterioration state (a degree of deterioration at that point) of power storage unit 10 based on the capacity and the internal resistance of power storage unit 10. Although deterioration detector 21 detects a deterioration state of power storage unit 10 by detecting internal resistance and capacity of power storage unit 10, a method for detecting the deterioration state may be changed, as necessary.

Controller 22 is configured to control, according to a detection result of the deterioration state of power storage unit 10 detected by deterioration detector 21, the set value (target value) of the charging voltage when charging circuit 11 charges power storage unit 10. When deterioration of power storage unit 10 is advanced, the capacity of power storage unit 10 decreases and the internal resistance thereof increases. Therefore, according to the detection result of deterioration detector 21, controller 22 controls the set value of the charging voltage to increase the set value of the charging voltage as deterioration of power storage unit 10 is advanced.

According to the detection result of the deterioration state of power storage unit 10, controller 22 controls the set value of the charging voltage to cause the set value of the charging voltage to be a voltage value required for charging power storage unit 10 to a predetermined storage amount. The predetermined storage amount is a storage amount that allows the minimum operating voltage or more to be supplied to load 3 for predetermined power supply time or more in the failure state. In other words, depending on the detection result of deterioration detector 21, controller 22 controls the set value of the charging voltage (when charging circuit 11 charges power storage unit 10) to cause the set value to be a voltage value at which power (required power) required for load 3 to perform a predetermined operation is supplied. Thus, in a failure state of power supply 2, backup power supply system 1 supplies power required for the operation to load 3 from power storage unit 10.

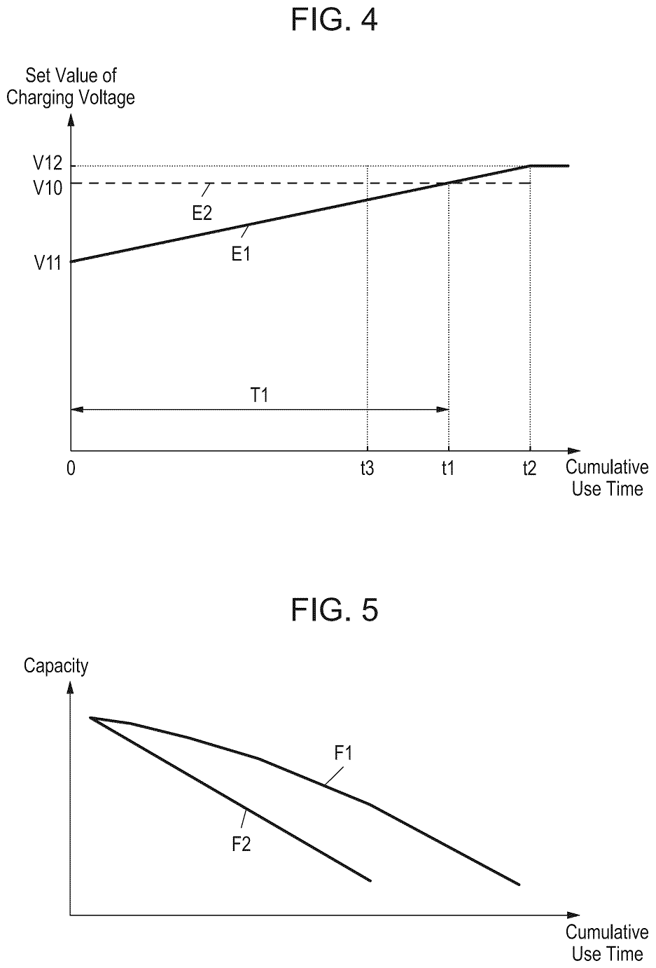

FIG. 4 shows a relationship between cumulative use time of power storage unit 10 and the set value of the charging voltage. Profile E1 in the figure represents the set value of the charging voltage when controller 22 changes the set value of the charging voltage according to the deterioration state of power storage unit 10. Profile E2 in the figure represents the set value of the charging voltage when the set value of the charging voltage is set to fixed value V10 regardless of a deterioration state of power storage unit 10. Fixed value V10 is set to a voltage value of the charging voltage required for supplying the required power to load 3 from power storage unit 10, based on capacity and internal resistance of power storage unit 10 in an end-of-life stage at which cumulative use time of power storage unit 10 reaches a predetermined lifetime.

As shown in FIGS. 2 and 3, in an initial use stage of power storage unit 10, the capacity of power storage unit 10 is larger and the internal resistance thereof is smaller than the case where power storage unit 10 has been used for a long time. Therefore, in the initial use stage of power storage unit 10, the set value of the charging voltage is set to set value V11 smaller than fixed value V10. When deterioration of power storage unit 10 is advanced as cumulative use time of power storage unit 10 increases, the set value of the charging voltage is increased gradually by controller 22 as the cumulative use time increases. In FIG. 4, time t3 indicates a lifetime of power storage unit 10 in the case where the set value of the charging voltage is set to fixed value V10. On the other hand, in backup power supply system 1 of the present exemplary embodiment, the set value of the charging voltage is set to a voltage value lower than fixed value V10 during period T1 before time t1. Thus, the present exemplary embodiment slows down the deterioration of power storage unit 10 as compared with the case where the set value of the charging voltage is controlled to a fixed value (fixed value V10), thereby extending the lifetime from t3 to t1. FIG. 5 shows a relationship between cumulative use time and capacity of power storage unit 10. Profile F1 shown in FIG. 5 represents a change in the capacity when the set value of the charging voltage is changed depending on the deterioration state as in profile E1 shown in FIG. 4. Profile F2 shown in FIG. 5 represents a change in the capacity when the set value of the charging voltage is set to fixed value V10 as in profile E2 shown in FIG. 4.

As shown in FIG. 4, controller 22 controls the set value of the charging voltage in an initial use stage to cause the set value to be set to value V11 lower than fixed value V10, and to increase gradually as deterioration of power storage unit 10 is advanced. Thus, degradation of the capacity of power storage unit 10 is delayed as compared with the case where the set value of the charging voltage is fixed to fixed value V10. Therefore, backup power supply system 1 according to the present exemplary embodiment slows down deterioration of power storage unit 10.

When the cumulative use time of power storage unit 10 becomes time t2 and the set value of the charging voltage reaches upper limit value V12 (see FIG. 4), controller 22 maintains the set value of the charging voltage to upper limit value V12. In other words, controller 22 controls the set value of the charging voltage within a voltage range of upper limit value V12 or less. Upper limit value V12 of the charging voltage is decreased by a predetermined margin voltage from a voltage value at which abnormalities, such as valve opening or gas generation, may occur in the EDLC constituting power storage unit 10. When the set value of the charging voltage reaches upper limit value V12, controller 22 maintains the set value of the charging voltage at upper limit value V12. Power storage unit 10 is prevented from being charged to a voltage higher than upper limit value V12, thereby reducing a possibility that abnormalities may occur in power storage unit 10.

When the set value of the charging voltage which is determined by controller 22 reaches upper limit value V12, notification unit 23 causes communication circuit 15 to transmit a notification signal to ECU 4 of vehicle 100. The notification signal indicates that power storage unit 10 has reached its life end. Based on the notification signal received from backup power supply system 1, ECU 4 is noticed that power storage unit 10 has reached its life end.

When communication circuit 15 receives stop information of vehicle 100 from ECU 4, controller 22 determines a discharge amount of power storage unit 10 based on the stop information, and outputs a discharge instruction to discharging circuit 14. In other words, when receiving the stop information indicating that vehicle 100 is stopped, controller 22 outputs the discharge instruction to discharging circuit 14. When receiving the discharge instruction, discharging circuit 14 turn on a switch to cause the electric charges to flow from power storage unit 10 to a discharge resistance through the switch, so that power storage unit 10 is discharged. When communication circuit 15 receives the stop information of vehicle 100 from ECU 4, controller 22 outputs a discharge instruction to discharging circuit 14, thereby causing power storage unit 10 to discharge electric charges. When vehicle 100 is stopped, backup power supply system 1 does not need to supply power to load 3. Therefore, controller 22 controls discharging circuit 14 to reduce terminal voltage VB of power storage unit 10, thereby slowing down deterioration of power storage unit 10 more effectively.

The stop information input from ECU 4 includes information indicating a stopping state of vehicle 100. The information which indicates the stopping state of vehicle 100 includes information indicating, e.g., one of the situation that a shift lever of vehicle 100 is set in parking (parking state), the situation that a handbrake of vehicle 100 is operated, and the situation that travel speed of vehicle 100 becomes zero. Depending on the stopping state of vehicle 100, travel restart time until vehicle 100 restarts traveling is different. Since it is necessary to finish charging power storage unit 10 to the set value of the charging voltage before vehicle 100 restarts traveling, a discharge amount of power storage unit 10 is preferably controlled by controller 22 such that the discharge amount from power storage unit 10 is smaller as the travel restart time determined from the stop information is shorter.

Controller 22 may control, based on the stop information and the deterioration state of power storage unit 10, the discharge amount which is discharged from power storage unit 10 through discharging circuit 14. In other words, controller 22 may determine a discharge amount of power storage unit 10 based on both the stop information and the deterioration state of power storage unit 10. After calculating the discharge amount based on travel restart time determined from the stop information, controller 22 adjusts, depending on a deterioration state of power storage unit 10, the discharge amount which is calculated from the stop information. For instance, when deterioration of power storage unit 10 is advanced, the capacity of power storage unit 10 decreases, so that the time required for charging power storage unit 10 decreases. Therefore, controller 22 may control a discharge amount of power storage unit 10 such that the discharging amount increases as deterioration of power storage unit 10 is advanced. When vehicle 100 is stopped, controller 22 thus controls discharging circuit 14 so as to reduce terminal voltage VB of power storage unit 10, thereby slowing down deterioration of power storage unit 10 more effectively.

### (2.2) Description of Operation

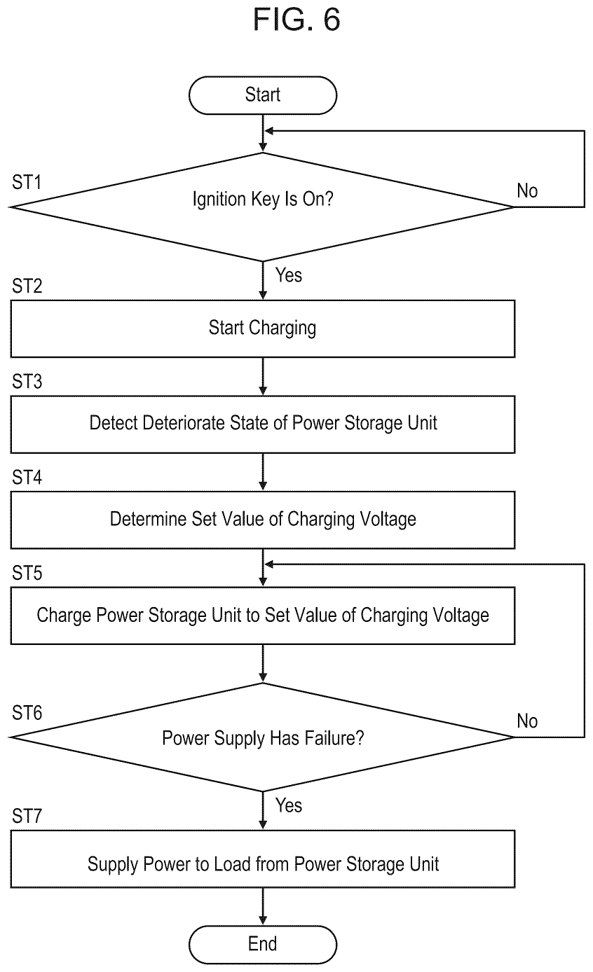

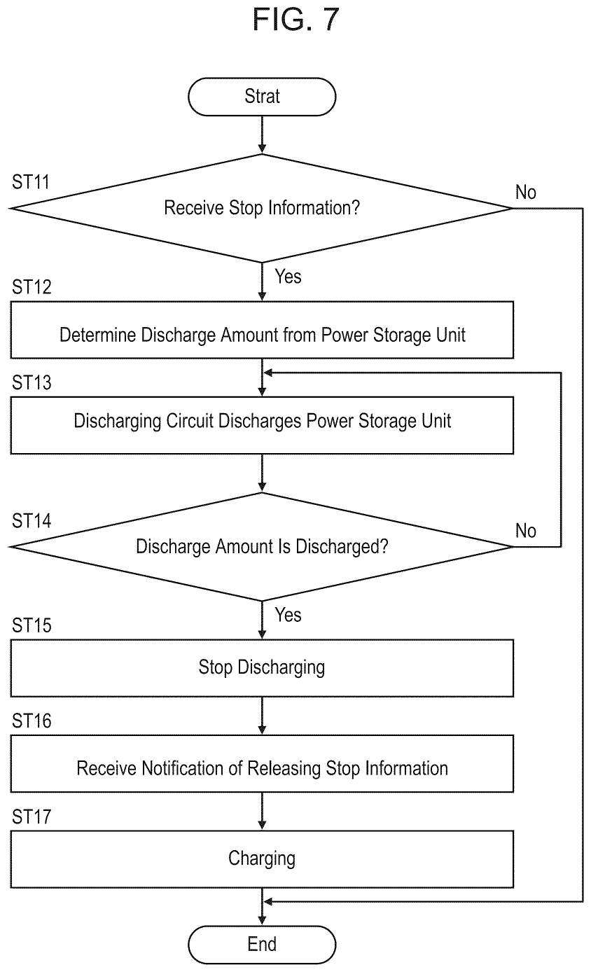

An operation of backup power supply system 1 according to the present exemplary embodiment will be described with reference to FIGS. 6 and 7. Flowcharts shown in FIGS. 6 and 7 are merely an example of a method for controlling backup power supply system 1 in accordance with the present exemplary embodiment. The order of processing may be changed suitably, and processing may be added or omitted, as necessary.

First, an operation in which backup power supply system 1 charges power storage unit 10 will be described along the flowchart of FIG. 6.

Upon having an ignition key of vehicle 100 turned on (step ST1: Yes), backup power supply system 1 starts operating, and controller 22 causes charging circuit 11 to start charging power storage unit 10 (step ST2).

Current I1 flows from charging circuit 11 to power storage unit 10, and gradually increases terminal voltage VB of power storage unit 10 accordingly. Then, deterioration detector 21 calculates internal resistance and capacity of power storage unit 10 based on detection results of current I1 and terminal voltage VB. Deterioration detector 21 detects a deterioration state of power storage unit 10 based on the internal resistance and the capacity of power storage unit 10 (step ST3).

Upon deterioration detector 21 detecting the deterioration state of power storage unit 10, controller 22 determines the set value of the charging voltage of power storage unit 10 according to a detection result of the deterioration state of power storage unit 10 (step ST4). Controller 22 determines the set value of the charging voltage to cause the set value of the charging voltage to be a voltage value for power storage unit 10 to store a storage amount enough to supply the required power to load 3 from power storage unit 1.

Upon determining the set value of the charging voltage, controller 22 controls charging circuit 11 to charge power storage unit 10 such that terminal voltage VB of power storage unit 10 becomes the set value determined in step ST4 (step ST5).

While power storage unit 10 is continuously charged, controller 22 monitors whether or not a failure state of power supply 2 occurs based on a detection signal input from failure detector 13 (step ST6).

When a failure state of power supply 2 does not occur (step ST6: No), controller 22 returns to step ST5 and charges power storage unit 10 continuously.

On the other hand, when a failure state of power supply 2 occurs (step ST6: Yes), controller 22 controls output circuit 12 such that power is supplied to load 3 from power storage unit 10 (step ST7), thereby allowing load 3 to operate even in a failure state of power supply 2.

In backup power supply system 1 according to the present exemplary embodiment, interruption processing is performed such that, in the state where power storage unit 10 is charged, if vehicle 100 is stopped temporarily, power storage unit 10 is discharged, i.e., interruption processing is performed. This interruption processing will be along the flowchart of FIG. 7.

If vehicle 100 is stopped temporarily while power storage unit 10 is charged to the set value of the charging voltage, communication circuit 15 receives stop information from ECU 4 of vehicle 100 (step ST11: Yes). At that moment, controller 22 determines, according to the stop information, a discharge amount to be discharged from power storage unit 10 (step ST12). Then, controller 22 outputs a discharge instruction to discharging circuit 14, and discharges electric charges stored in power storage unit 10 through discharging circuit 14 (step ST13).

If a discharge amount from power storage unit 10 does not reach the discharged amount determined in step ST12 (step ST14: No), controller 22 controls discharging circuit 14 so as to continuously discharge power storage unit 10.

On the other hand, when the discharge amount from power storage unit 10 reaches the discharge amount determined in step ST12 (step ST14: Yes), controller 22 causes discharging circuit 14 to stop discharging of power storage unit 10 (step ST15). After that, when receiving a notification of releasing the stop information from ECU 4 (step ST16), controller 22 controls charging circuit 11 to charge power storage unit 10 (step ST17), so that power storage unit 10 is charged, before vehicle 100 starts traveling, to the set value of the charging voltage determined in step ST4.

If the stop information is not received in step ST11 (Step ST11: No), controller 22 completes the interruption processing.

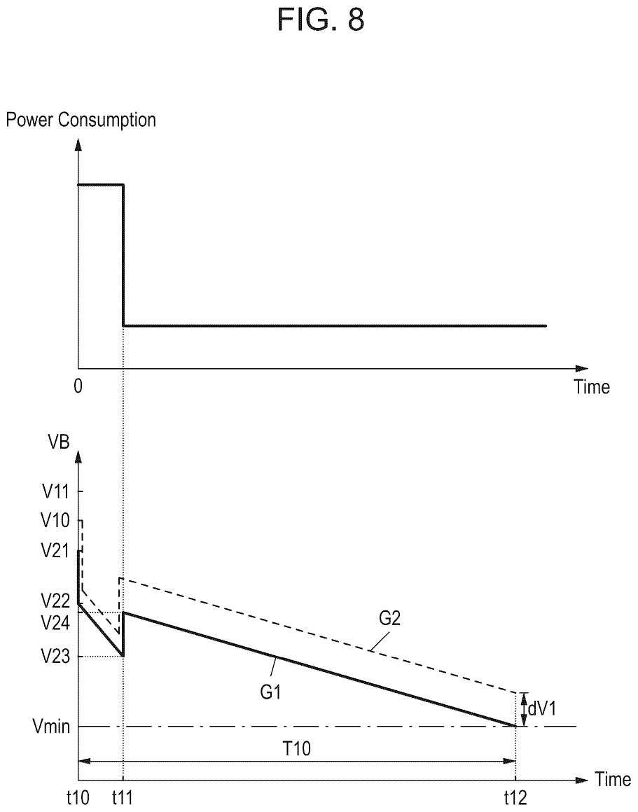

FIG. 8 shows changes with respect time of power supplied to load 3 and terminal voltage VB of power storage unit 10 when power is supplied to load 3 from power storage unit 10 due to occurrence of a failure state of the power supply in an initial use stage of power storage unit 10. Profile G1 shown in FIG. 8 represents a waveform when the set value of the charging voltage is set to set value V21 in accordance with the deterioration state of power storage unit 10. Profile G2 shown in FIG. 8 represents a waveform when the set value of the charging voltage is set to fixed value V10.

In the case where backup power supply system 1 starts supplying power to load 3 due to occurrence of a failure state of power supply 2 at time point t10, power consumption of load 3 is large during a period to time point t11 from time point t10 when load 3 starts operation. After time point t11, the power consumption of load 3 decreases. For that reason, the current flowing to load 3 increases rapidly at time point t10, and terminal voltage VB of power storage unit 10 rapidly falls to voltage value V22 from initial set value V21 at time point t10. After that, terminal voltage VB decreases gradually until time point t11. When the power supplied to load 3 falls rapidly at time point t11, terminal voltage VB of power storage unit 10 is recovered to voltage value V24 from voltage value V23 and, after that, decreases gradually from voltage value V24. In power supply time T10 from time point t10 to time point t12, terminal voltage VB of power storage unit 10 is more than or equal to minimum operating voltage Vmin of load 3. Therefore, the power required for the operation is supplied to load 3 from power storage unit 10.

In the case that the set value of the charging voltage of power storage unit 10 is set to fixed value V10, power storage unit 10 is charged to fixed value V10 higher than set value V21 which is determined based on a deterioration state of power storage unit 10. Therefore, even at time point t12, i.e., when predetermined power supply time T10 elapses from time point t10, terminal voltage VB of power storage unit 10 becomes higher by difference dV1. In the case that the set value of the charging voltage of power storage unit 10 is set to fixed value V10, in a period (initial use stage or the like) in which deterioration of power storage unit 10 is not advanced compared with in an end-of-life stage, the set value of the charging voltage is set to be excessively high compared with the case where the set value of the charging voltage is determined based on a deterioration state of power storage unit 10. On the other hand, in accordance with the present exemplary embodiment, controller 22 determines the set value of the charging voltage based on a deterioration state of power storage unit 10. Therefore, terminal voltage VB of power storage unit 10 is lower than the case where the set value of the charging voltage is set to fixed value V10. This configuration suppresses deterioration of power storage unit 10, thereby slowing down progress of deterioration of power storage unit 10.

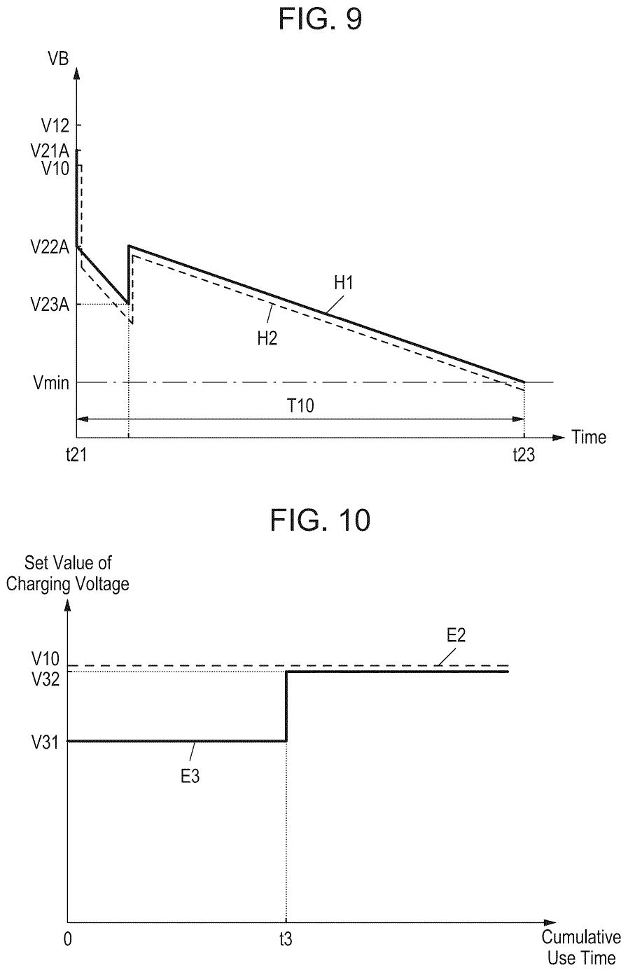

FIG. 9 shows a change with respect to time of terminal voltage VB of power storage unit 10 when power is supplied to load 3 from power storage unit 10 due to occurrence of a failure state of power supply 2 in an end-of-life state in which cumulative use time of power storage unit 10 exceeds the lifetime. Profile H1 shown in FIG. 9 represents a change with respect time of terminal voltage VB when the set value of the charging voltage is set to set value V21A in accordance with a deterioration state of power storage unit 10. Profile H2 shown in FIG. 9 represents a change with respect to time of terminal voltage VB when the set value of the charging voltage is set to fixed value V10.

In the end-of-life state in which the cumulative use time exceeds the lifetime, in the case that the set value of the charging voltage is set to constant fixed value V10, terminal voltage VB of power storage unit 10 falls below minimum operating voltage Vmin at time point t23 when predetermined power supply time T10 has elapsed from time point t21 when power supply from power storage unit 10 to load 3 is started. This situation causes the required power to be hardly supplied to load 3.

On the other hand, in accordance with the present exemplary embodiment, controller 22 determines the set value of the charging voltage based on a deterioration state of power storage unit 10. The set value of the charging voltage which is set to set value V21A higher than fixed value V10 in the end-of-life state maintains terminal voltage VB of power storage unit 10 to a voltage higher than minimum operating voltage Vmin even at time point t23 when power supply time T10 has elapsed from time point t21. In other words, controller 22 determines the set value of the charging voltage based on a deterioration state of power storage unit 10, and allows the required power which is required for load 3 to operate to be supplied to load 3 from power storage unit 10. In the case that controller 22 sets the set value of the charging voltage to a voltage value higher than fixed value V10, power storage unit 10 can be used with the life extended compared with the case where the set value of the charging voltage is set to constant fixed value V10.

In the case where controller 22 sets the set value of the charging voltage based on a deterioration state of power storage unit 10, if the set value of the charging voltage reaches upper limit value V12, controller 22 restricts the set value of the charging voltage to upper limit value V12. At this moment, notification unit 23 transmits a notification signal to ECU 4 of vehicle 100 from communication circuit 15. The notification signal indicates that power storage unit 10 has reached its life end. ECU 4 of vehicle 100 is thus notified that power storage unit 10 has reached its life end.

### (3) Modifications

The above-mentioned exemplary embodiment is merely one of various exemplary embodiments of the present disclosure. The above-mentioned exemplary embodiment may be modified variously according to the design or the like if objects of the present disclosure can be achieved. Further, the same function as backup power supply system 1 may be embodied in a method for controlling backup power supply system 1, a computer program, a non-transitory recording medium in which the program is stored, or the like. The method for controlling backup power supply system 1 in accordance with one aspect is a method for controlling backup power supply system 1 provided with first port P1, second port P2, charging circuit 11, and output circuit 12. The method includes deterioration detection processing and control processing. Power supply 2 is connectable with first port P1. Load 3 is connectable with second port P2. Charging circuit 11 charges power storage unit 10 using power input from power supply 2 through first port P1. In a failure state in which power supply 2 has failed, output circuit 12 supplies power to load 3 from power storage unit 10 through second port P2. In the deterioration detection processing, a deterioration state of power storage unit 10 is detected. In the control processing, the set value of the charging voltage when charging circuit 11 charges power storage unit 10 is controlled depending on a detection result of the deterioration state of power storage unit 10. The (computer) program in accordance with one aspect is a program for causing a computer system to execute the method for controlling backup power supply system 1.

Modifications of the above-mentioned exemplary embodiments will be listed below. The modifications described below may be combined suitably and applied. In the following, backup power supply system 1 according to above-mentioned exemplary embodiment may be called a basic configuration.

Backup power supply system 1 according to the present disclosure includes a computer system. The computer system is mainly constituted by a processor and a memory as hardware. The processor executes a program, which is stored in the memory of the computer system, to achieve a function of backup power supply system 1 in the present disclosure. The program may be stored in the memory of the computer system in advance. Alternatively, the program may be provided through an electric communication line, or may be stored in a non-transitory recording medium, such as a computer-readable memory card, an optical disk, and a hard disk drive, and provided. A processor of the computer system is constituted by one or more electronic circuits including a semiconductor integrated circuit (IC) or a large-scale integrated circuit (LSI). The integrated circuits herein, such as an IC or an LSI, of which the names are different depending on a degree of integration include integrated circuits called a system LSI, a VLSI (Very Large Scale Integration), or a ULSI (Ultra Large Scale Integration). Furthermore, an FPGA (Field-Programmable Gate Array) that is programmed after manufacture of an LSI or a logic device that enables reconstruction of a connection relationship inside an LSI or reconstruction of a circuit area inside an LSI can also be employed as the processor. Two or more electronic circuits may be collected into one chip, or may be distributed into two or more chips and provided. Two or more chips may be collected into one device, or may be distributed into two or more devices and provided. The computer system herein includes a microcontroller that has one or more processors and one or more memories. Accordingly, the microcontroller is also constituted by one or more electronic circuits including a semiconductor integrated circuit or a large-scale integrated circuit.

### (3.1) Modification 1

In the basic configuration, controller 22 is configured to change the set value of the charging voltage among continuous values according to a detection result of a deterioration state of power storage unit 10 through deterioration detector 21, but may change the set value of the charging voltage among discrete values. FIG. 10 shows a relationship between cumulative use time of power storage unit 10 and the set value of the charging voltage.

Deterioration detector 21 compares a level of the deterioration state calculated from internal resistance or capacity of power storage unit 10 with a predetermined threshold. The level of the deterioration state indicates a degree of progress of deterioration, i.e., indicates that deterioration is more advanced as a level of the deterioration state becomes larger. For instance, since the level of the deterioration state of power storage unit 10 is less than or equal to a threshold until cumulative use time of power storage unit 10 is time t3, deterioration detector 21 determines that the deterioration state of power storage unit 10 is a first deterioration stage. Further, when cumulative use time of power storage unit 10 exceeds time t3, the level of the deterioration state of power storage unit 10 exceeds the threshold. Then, deterioration detector 21 determines that the deterioration state of power storage unit 10 is a second deterioration stage.

Based on the detection result of deterioration detector 21, in the case that the deterioration state of power storage unit 10 is the first deterioration stage, controller 22 sets the set value of the charging voltage to set value V31. Further, in the case that the deterioration state of power storage unit 10 is the second deterioration stage, controller 22 sets the set value of the charging voltage to set value V32 (V31<V32). In other words, in the case that the deterioration state of power storage unit 10 includes: a first deterioration stage in which the level of the deterioration state is less than or equal to a predetermined threshold; and a second deterioration stage in which the level of the deterioration state exceeds the predetermined threshold are included in the deterioration state of power storage unit 10, controller 22 controls set value V32 of the charging voltage in the second deterioration stage to cause set value V32 to be higher than set value V31 of the charging voltage in the first deterioration stage.

Controller 22 sets set value V31 of the charging voltage in the first deterioration stage to be lower than set value V32 of the charging voltage in the second deterioration stage. This configuration prevents deterioration of power storage unit 10, thereby slowing down progress of deterioration of power storage unit 10. Further, controller 22 changes the set value of the charging voltage of power storage unit 10 to discrete values according to the detection result of the deterioration state of power storage unit 10 detected by deterioration detector 21. This configuration allows charging circuit 11 to have a simple configuration compared with the case where the set value of the charging voltage is changed continuously.

The level of the deterioration state which is calculated from internal resistance or capacity of power storage unit 10 is compared with each of plural thresholds. Deterioration detector 21 may determine that the deterioration state of power storage unit 10 is one of three or more deterioration stages. In other words, plural thresholds are provided, and deterioration detector 21 determines that the deterioration state is any one of the three or more deterioration stages by comparing the deterioration state of power storage unit 10 with each of the plural thresholds. In this case, controller 22 sets the set value of the charging voltage in each of the three or more deterioration stages. Specifically, it is assumed that, in any two deterioration stages among the three or more deterioration stages, one is in a low deterioration stage and the other is in a high deterioration stage in which the deterioration is more advanced than that in the low deterioration stage. Controller 22 sets the set value of the charging voltage in the low deterioration stage to be lower than the set value of the charging voltage in the high deterioration stage. In other words, controller 22 controls the set value of the charging voltage in one of the three or more deterioration stages to cause the set value to be lower than the set value in another deterioration stage in which the deterioration is more advanced than that in the one of the three or more deterioration stages. Thus, in the low deterioration stage in which the deterioration is not advanced compared with in the high deterioration stage, the set value of the charging voltage can be set to a lower voltage. Therefore, the deterioration of power storage unit 10 can be prevented, thereby slowing down progress of the deterioration.

### (3.2) Other Modifications

In the basic configuration, as to a comparison between two values, such as a measurement result of voltage, “more than or equal to” may be considered as “more than.” In other words, in a comparison between the two values, whether the equality of two values is included or not can be changed optionally depending on setting of a reference value or the like. Therefore, there is no technical difference between “more than or equal to” and “more than.” Similarly, “less than” may be considered as “less than or equal to.” In the basic configuration, the semiconductor switch element included in charging circuit 11 is not necessarily implemented by a MOSFET, but may be another semiconductor switch, such as an insulated gate bipolar transistor (IGBT). The circuit configuration of charging circuit 11 may be changed as necessary, and may be constituted by a DC-DC converter configured to boost and down voltage. Furthermore, the semiconductor switch included in output circuit 12 is not necessarily implemented by a MOSFET, but may be implemented by another semiconductor switch, such as an IGBT. The circuit configuration of output circuit 12 may also be changed as necessary, and may be constituted by a DC-DC converter configured to boost of step down voltage.

In the basic configuration, power storage unit 10 may be a rechargeable battery, such as a lithium ion capacitor (LIC) or a lithium ion battery (LIB). The lithium ion capacitor includes: a positive electrode made of the same material (e.g., activated carbon) as an EDLC; and a negative electrode made of the same material (e.g., carbon material such as graphite) as a LIB.

Further, power storage unit 10 is not necessarily the electrical double layer capacitor, but may be an electrochemical device having configuration described in the following. The electrochemical device includes a positive electrode, a negative electrode, and nonaqueous electrolytic. The positive electrode includes a positive-electrode current collector and a positive-electrode material layer supported by the positive-electrode current collector and containing a positive-electrode active material. The positive-electrode material layer contains conductive polymer as positive-electrode active material for doping and de-doping anion (dopant). The negative electrode includes a negative-electrode material layer containing negative-electrode active material. As an example, the negative-electrode active material is a substance in which oxidation-reduction reaction with intercalation and de-intercalation of lithium ions is proceeded. Specifically, the negative-electrode active material is carbon material, metallic compound, alloy, ceramic material, or the like. The nonaqueous electrolytic solution has lithium ion conductivity, as an example. Such nonaqueous electrolytic solution contains lithium salt and non-aqueous solution in which the lithium salt is dissolved. The electrochemical device has higher energy density than an electrical double layer capacitor.

In the basic configuration, backup power supply system 1 mounted to a vehicle has been described as an example, but backup power supply system 1 may be mounted to a movable body, such as an airplane, a ship, or a train. Backup power supply system 1 is not necessarily a backup power supply system mounted to the movable body, but may be installed to facilities.

### SUMMARY

The following aspects are disclosed from the exemplary embodiments described above.

A backup power supply system (1) according to a first aspect includes a first port (P1), a second port (P2), a charging circuit (11), an output circuit (12), a deterioration detector (21), and a controller (22). The first port (P1) is configured to be connected to the power supply (2). The second port (P2) is configured to be connected to a load (3). The charging circuit (11) is configured to charge power storage unit (10) such that a charging voltage which is a voltage of power storage unit (10) becomes a set value with power input from the power supply (2) through the first port (P1). In a failure state in which the power supply (2) has failure, the output circuit (12) is configured to supply power to the load (3) from the power storage unit (10) through the second port (P2). The deterioration detector (21) is configured to detect a deterioration state of the power storage unit (10). According to a detection result of the deterioration detector (21), the controller (22) is configured to control the set value of the charging voltage while the charging circuit (11) charges the power storage unit (10).

According to this aspect, in an initial use stage in which capacity of the power storage unit (10) is larger and internal resistance thereof is smaller than in an end-of-life stage of the power storage unit (10), the controller (22) controls the set value of the charging voltage to cause the set value to be lower than a voltage value in the end-of-life stage. Since deterioration of the power storage unit (10) is advanced more easily as the set value of the charging voltage is higher, the controller (22) controls the set value of the charging voltage in the initial use stage to be lower than a voltage value in the end-of-life stage. Thus, deterioration of the power storage unit (10) is prevented, thereby extending the life of the power storage unit (10).

In the backup power supply system (1) according to a second aspect, in the first aspect, the controller (22) is configured to control the set value of the charging voltage to increase the set value as deterioration of the power storage unit (10) is advanced.

According to this aspect, the set value of the charging voltage in the initial use stage is controlled to be lower than a voltage value in the end-of-life stage, thereby preventing deterioration of the power storage unit (10). The controller (22) controls the set value of the charging voltage to increase the set value as deterioration of the power storage unit (10) is advanced. Thus, the power required for the load (3) to operate is supplied even if the capacity of the power storage unit (10) is decreased.

In the backup power supply system (1) of a third aspect, in the first aspect, the deterioration detector (21) is configured to determine whether a deterioration state of the power storage unit (10) is in a first deterioration stage in which a level of the deterioration state is less than or equal to a predetermined threshold or in a second deterioration stage in which a level of the deterioration state exceeds the predetermined threshold. The controller (22) is configured to control the set value of the charging voltage in the second deterioration stage to cause the set value of the charging voltage in the second deterioration stage to be higher than the set value of the charging voltage in the first deterioration stage.

According to this aspect, the set value of the charging voltage in the first deterioration stage is set to be lower than the set value of the charging voltage in the second deterioration stage, thereby preventing deterioration of the power storage unit (10).

In the backup power supply system (1) of a fourth aspect, in the first aspect, the deterioration detector (21) is configured to compare a deterioration state of the power storage unit (10) with a plurality of thresholds to determine that the deterioration state is in one of three or more deterioration stages. The controller (22) is configured to control the set value of the charging voltage in one of the three or more deterioration stages to cause the set value to be lower than the set value of the charging voltage in another deterioration stage of the three or more deterioration stages in which the deterioration is more advanced than that in the one of the three or more deterioration stages.

According to this aspect, the controller (22) controls the set value of the charging voltage in a low deterioration stage to be lower than the set value of the charging voltage in a high deterioration stage, thereby preventing deterioration of the power storage unit (10).

In the backup power supply system (1) according to a fifth aspect, in any of the first to fourth aspects, the controller (22) is configured to control, according to a detection result of the deterioration detector (21), the set value of the charging voltage to allow the set value of the charging voltage to supply, to the load (3), power required for the load (3) to perform a predetermined operation.

According to this aspect, in the backup power supply system (1), the power required to perform a predetermined operation is supplied to the load (3) from the power storage unit (10) in a failure state of the power supply (2).

In the backup power supply system (1) according to a sixth aspect, the power supply (2) and the load (3) are configured to be mounted to a vehicle (100) in any of the first to fifth aspects. The backup power supply system (1) includes a discharging circuit (14). When a discharge instruction is input from the controller (22), the discharging circuit (14) is configured to discharge electric charges stored in the power storage unit (10). When receiving stop information indicating that the vehicle (100) is stopped, the controller (22) is configured to output the discharge instruction to the discharging circuit (14).

According to this aspect, when the vehicle (100) is stopped, the backup power supply system (1) does not need to supply power to the load (3). Therefore, the controller (22) controls the discharging circuit (14) so as to reduce a terminal voltage of the power storage unit (10), thereby preventing deterioration of the power storage unit (10) more effectively.

In the backup power supply system (1) according to a seventh aspect, in the sixth aspect, the controller (22) is configured to control a discharging amount discharged from the power storage unit (10) through the discharging circuit (14) according to the stop information and the deterioration state of the power storage unit (10).

According to this aspect, the controller (22) controls a discharging amount discharged from power storage unit (10), according to the stop information and the deterioration state of power storage unit (10). Therefore, the discharging amount is controlled to an appropriate value.

In the backup power supply system (1) according to an eighth aspect, in any of the first to seventh aspects, the power storage unit (10) includes an electrical double layer capacitor.

According to this aspect, even when power storage unit (10) includes an electrical double layer capacitor, deterioration of the electrical double layer capacitor can be prevented.

A method for controlling a backup power supply system (1) in the ninth aspect is a method for controlling a backup power supply system (1) including a first port (P1), a second port (P2), a charging circuit (11), and an output circuit (12). The method includes a deterioration detection processing and a control processing. The first port (P1) is connected to a power supply (2). The second port (P2) is connected to a load (3). The charging circuit (11) is configured to charge the power storage unit (10) such that a charging voltage which is a voltage of the power storage unit (10) becomes a set value with power input from the power supply (2) through the first port (P1). The output circuit (12) is configured to supply power to the load (3) from the power storage unit (10) through the second port (P2) in a failure state in which the power supply (2) has failure. In the deterioration detection processing, a deterioration state of the power storage unit (10) is detected. In the control processing, the set value of the charging voltage when the charging circuit (11) charges the power storage unit (10) is controlled according to a detection result of the deterioration state of the power storage unit (10).

According to this aspect, in an initial use stage in which capacity of the power storage unit (10) is larger and internal resistance thereof is smaller than in an end-of-life stage of the power storage unit (10), the set value of the charging voltage is controlled to cause the set value to be lower than a voltage value in the end-of-life stage. Since deterioration of the power storage unit (10) is advanced more easily as a terminal voltage of the power storage unit (10) is higher, if the set value of the charging voltage in the initial use stage is controlled to be lower than a voltage value in the end-of-life stage, the deterioration of the power storage unit (10) is prevented.

Various configurations (modification is included) of backup power supply system (1) in accordance with the above-mentioned exemplary embodiments can be achieved by not only the above-mentioned aspects, but also a method for controlling backup power supply system (1), a (computer) program, a non-transitory recording media in which the program is stored, or the like.

The configurations in accordance with the second to eighth aspects are not essential to backup power supply system (1), but may be omitted, as necessary.

Further, the sixth and seventh aspects, which can be performed independently, are not essentially on any of the first to fifth aspects. In other words, a backup power supply system (1) in accordance with the sixth aspect, which is mounted to a vehicle (100), may include a first port (P1), a second port (P2), a charging circuit (11), a output circuit (12), a controller (22), and a discharging circuit (14). The first port (P1) is configured to be connected to a power supply (2). The second port (P2)is configured to be connected to a load (3). The charging circuit (11) is configured to charge the power storage unit (10) with power input from the power supply (2) through the first port (P1). The output circuit (12) is configured to supply power to the load (3) from the power storage unit (10) through the second port (P2) in a failure state in which power supply (2) has failure. Upon receiving a discharge instruction input from the controller (22), the discharging circuit (14) is configured to discharges electric charges stored in the power storage unit (10). When receiving stop information indicating that the vehicle (100) is stopped, the controller (22) is configured to output the discharge instruction to the discharging circuit (14). In this case, the backup power supply system (1) does not essentially include the deterioration detector (21), and the controller (22) does not essentially control the set value of the charging voltage when the charging circuit (11) charges the power storage unit (10) depending on a detection result of the deterioration detector (21). The charging voltage of the power storage unit (10) may be set to a fixed voltage value.

### REFERENCE MARKS IN THE DRAWINGS

1 backup power supply system
2 power supply
3 load
10 power storage unit
11 charging circuit
12 output circuit
14 discharging circuit
21 deterioration detector
22 controller
100 vehicle
P1 first port
P2 second port

1. A backup power supply system comprising:
a first port configured to be connected to a power supply;
a second port configured to be connected to a load;
a charging circuit configured to charge a power storage unit such that a charging voltage which is a voltage of the power storage unit has a set value with power input from the power supply through the first port;
an output circuit configured to supply power to the load from the power storage unit through the second port during a failure state in which the power supply has failure;
a deterioration detector configured to detect a deterioration state of the power storage unit; and
a controller configured to control the set value depending on a detection result of the deterioration detector.

2. The backup power supply system according to claim 1, wherein the controller is configured to control the set value of the charging voltage to increase the set value of the charging voltage as deterioration of the power storage unit is advanced.

3. The backup power supply system according to claim 1, wherein
the deterioration detector is configured to determine whether a deterioration state of the power storage unit is in either a first deterioration stage in which a level of the deterioration state is less than or equal to a predetermined threshold or a second deterioration stage in which a level of the deterioration state exceeds the predetermined threshold, and
the controller is configured to control the set value of the charging voltage to cause the set value of the charging voltage in the second deterioration stage to be higher than the set value of the charging voltage in the first deterioration stage.

4. The backup power supply system according to claim 1, wherein
the deterioration detector is configured to compare the deterioration state of the power storage unit with a plurality of thresholds so as to determine that the deterioration state is one of three or more deterioration stages, and
the controller is configured to control the set value of the charging voltage to cause the set value of the charging voltage in the one of the three or more deterioration stages to be lower than the set value of the charging voltage in another deterioration stage out of the three or more deterioration stages in which deterioration is more advanced than in the one of the three or more deterioration stages.

5. The backup power supply system according to claim 1, wherein the controller is configured to control the set value of the charging voltage according to a detection result of the deterioration detector to allow the set value of the charging voltage to supply, to the load, power required for the load to perform a predetermined operation.

6. The backup power supply system according to claim 1, wherein
the power supply and the load are configured to be mounted to a vehicle, and
the backup power supply system further comprises a discharging circuit configured to discharge the power storage unit in response to a discharge instruction input from the controller, and
the controller is configured to output the discharge instruction to the discharging circuit upon receiving stop information indicating that the vehicle is stopped.

7. The backup power supply system according to claim 6, wherein the controller is configured to control, according to the stop information and the deterioration state of the power storage unit, a discharging amount discharged from the power storage unit through the discharging circuit.

8. The backup power supply system according to claim 1, wherein the power storage unit includes an electrical double layer capacitor.

9. A method for controlling a backup power supply system, comprising:
providing a backup power supply system including
a first port connected to a power supply,
a second port connected to a load,
a charging circuit configured to charge a power storage unit such that a charging voltage which is a voltage of the power storage unit has a set value with power input from the power supply through the first port, and
an output circuit configured to supply power to the load from the power storage unit through the second port during a failure state in which the power supply has a failure;
detecting a deterioration state of a power storage unit; and
controlling the set value according to a detection result of the deterioration state of the power storage unit.
